(19) United States
(12) Patent Application Publication
(10) Pub. No.: US 2014/0334812 A1
(43) Pub. Date: Nov. 13, 2014

(54) WAVELENGTH MULTIPLEXING OPTICAL COMMUNICATION DEVICE

(71) Applicant: Yuita Noguchi, Tokyo (JP)

(72) Inventor: Yuita Noguchi, Tokyo (JP)

(73) Assignee: MITSUBISHI ELECTRIC CORPORATION, Tokyo (JP)

(21) Appl. No.: 14/362,324

(22) PCT Filed: Jan. 10, 2013
(86) PCT No.: PCT/JP13/50309

§ 371 Date: Jun. 2, 2014

(30) Foreign Application Priority Data
Jan. 13, 2012 (JP) 2012-004981

(51) Int. Cl. H04B 10/077; H04J 14/02; H04B 10/40

(52) U.S. Cl. CPC H04B 10/0779; H04B 10/40; H04J 14/02
USPC 398/22

(57) ABSTRACT

A wavelength multiplexing optical communication device includes: a pluggable LD module that generates a check optical signal having a specific wavelength; a multiplexer that multiplexes the check optical signal onto the transmitting-side optical fiber which links the transmitting-side connector with a corresponding output port of the optical demultiplexer, the transmitting-side connector being connected to the in-device optical fiber; a demultiplexer that demultiplexer the check optical signal from a receiving-side optical fiber which links the receiving-side connector with a corresponding input port of the optical multiplexer, the receiving-side connector being connected to the in-device optical fiber; a level detector that detects a level of the check optical signal obtained by the demultiplexer; and an erroneous connection detector that detects an erroneous connection of the in-device optical fiber in accordance with the detected level.

### TECHNICAL FIELD

The present invention relates to a wavelength multiplexing optical communication device that detects an erroneous connection of an in-device optical fiber connected between a transmitter and a receiver.

### BACKGROUND ART

There is a Patent Literature 1 presented in below as a conventional technique related to optical fiber erroneous connection detection. The Patent Literature 1 discloses an optical patch panel in which an optical fiber is connected by plugging an optical plug into an optical socket, and in which three states of a normal connection, an optical plug failure on the input side and an optical plug failure on the output side are individually displayed by an indicator.

In addition, there is a Patent Literature 2 presented in below as a conventional technique related to optical fiber erroneous connection detection. The Patent Literature 2 discloses an optical transmission device including a first optical fiber amplifier that performs intensity modulation using ID information which varies from optical signal to optical signal, a monitoring circuit that monitors a connection state for each optical signal by analyzing the intensity-modulated ID information, and a second optical fiber amplifier that removes an intensity modulation component caused by the first optical fiber amplifier.

### CITATION LIST

Patent Literature 1: JP 2007-57642 A

Patent Literature 2: JP 2004-40241 A

### SUMMARY OF INVENTION

Since the conventional devices are configured in the above-described manner, they have problems such as those shown below.

The Patent Literature 1 is intended to disclose a device in which right connection points are fixedly determined in advance. Due to this, there is a problem that an erroneous connection of an in-device optical fiber cannot be detected when the points where a port of a transmitter and a port of a receiver are connected to each other are arbitrarily set.

The Patent Literature 2 is required to perform a process in which the first optical fiber amplifier performs intensity modulation using ID information, the monitoring circuit analyzes the intensity-modulated ID information, and the second optical fiber amplifier removes an intensity modulation component. Therefore, a process for monitoring a connection state becomes complicated.

The present invention is made to solve problems described above. An object of the present invention is to provide a wavelength multiplexing optical communication device that detects, with a simple configuration, an erroneous connection of an in-device optical fiber in a case where a connection between a port of a transmitter and a port of a receiver is arbitrarily set.

According to the present invention, a wavelength multiplexing optical communication device including a transmitter and a receiver, the transmitter having: an optical demultiplexer that demultiplexer a wavelength-multiplexed light coming from an input port into light for each wavelength and outputs the demultiplexed light from individual output ports; transmitting-side connectors that is provided in correspondence with the output ports of the optical demultiplexer; and transmitting-side optical fibers that connect the output ports of the optical demultiplexer to the transmitting-side connectors provided in correspondence with the output ports, the receiver having: an optical multiplexer that multiplexes optical signals for each wavelength coming from a plurality of input ports and outputs the wavelength-multiplexed light from an output port; receiving-side connectors that is provided in correspondence with the input ports of the optical multiplexer; and receiving-side optical fibers that connect the input ports of the optical multiplexer to the receiving-side connectors provided in correspondence with the input ports, the transmitting-side connectors and the receiving-side connectors being connected by an in-device optical fiber, the wavelength multiplexing optical communication device includes: a connection check light source that generates a check optical signal; a multiplexer that multiplexes the check optical signal onto the transmitting-side optical fiber which links the transmitting-side connector with a corresponding output port of the optical demultiplexer, the transmitting-side connector being connected to the in-device optical fiber; a demultiplexer that demultiplexes the check optical signal from a receiving-side optical fiber which links the receiving-side connector with a corresponding input port of the optical multiplexer, the receiving-side connector being connected to the in-device optical fiber; and an erroneous connection detector that detects a level of the check optical signal obtained by the demultiplexer and detects an erroneous connection of the in-device optical fiber in accordance with the detected level.

According to the present invention, only by including a connection check light source, a multiplexer, a demultiplexer and an erroneous connection detector, an erroneous connection of an in-device optical fiber can be detected. Therefore, there is an effect of being able to detect, with a simple configuration, an erroneous connection of an in-device optical fiber in a case where a connection between a port of a transmitter and a port of a receiver is arbitrarily set.

### BRIEF DESCRIPTION OF DRAWINGS

FIG. 1 is a circuit diagram depicting a wavelength multiplexing optical communication device according to Embodiment 1 of the present invention.

FIG. 2 is a circuit diagram depicting a wavelength multiplexing optical communication device according to Embodiment 2 of the present invention.

FIG. 3 is a circuit diagram depicting a wavelength multiplexing optical communication device according to Embodiment 3 of the present invention.

FIG. 4 is a circuit diagram depicting a wavelength multiplexing optical communication device according to Embodiment 4 of the present invention.

FIG. 5 is a circuit diagram depicting a wavelength multiplexing optical communication device according to Embodiment 5 of the present invention.

### DESCRIPTION OF EMBODIMENT

In order to describe the invention in more detail, embodiments for implementing the invention will be described below with reference to the accompanying drawings.

### Embodiment 1

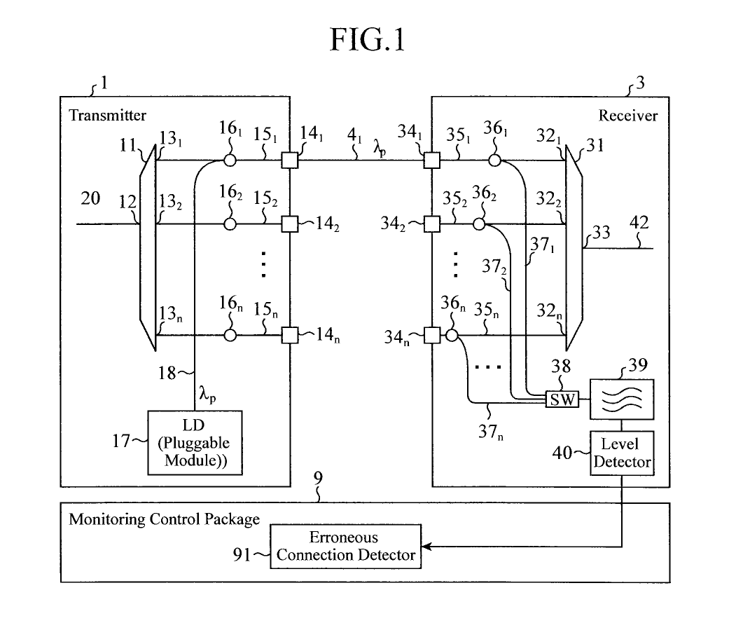

FIG. 1 is a circuit diagram depicting a wavelength multiplexing optical communication device according to Embodiment 1 of the present invention.

In the drawing, the wavelength multiplexing optical communication device includes a transmitter 1, a receiver 3, and a monitoring control package 9.

In the transmitter 1, an optical demultiplexer 11 demultiplexes a wavelength-multiplexed light coming from an input port 12 into light for each wavelength, and outputs the demultiplexed light from output ports 13₁, 13₂, . . . , 13ₙ.

Transmitting-side connectors 14₁, 14₂, . . . , 14ₙ are provided in correspondence with the output ports 13₁, 13₂, . . . , 13ₙ of the optical demultiplexer 11, respectively.

Transmitting-side optical fibers 15₁, 15₂, . . . , 15ₙ connect the output ports 13₁, 13₂, . . . , 13ₙ of the optical demultiplexer 11 to the transmitting-side connectors 14₁, 14₂, . . . , 14ₙ provided in correspondence with the output ports 13₁, 13₂, . . . , 13ₙ, respectively.

In the receiver 3, an optical multiplexer 31 multiplexes optical signals for each wavelength coming from input ports 32₁, 32₂, . . . , 32ₙ, and outputs the wavelength-multiplexed light from an output port 33.

Receiving-side connectors 34₁, 34₂, . . . , 34ₙ are provided in correspondence with the input ports 32₁, 32₂, . . . , 32ₙ of the optical multiplexer 31, respectively.

Receiving-side optical fibers 35₁, 35₂, . . . , 35ₙ connect the input ports 32₁, 32₂, . . . , 32ₙ of the optical multiplexer 31 to the receiving-side connectors 34₁, 34₂, . . . , 34ₙ provided in correspondence with the input ports 32₁, 32₂, . . . , 32ₙ, respectively.

An arbitrary transmitting-side connector 14 and an arbitrary receiving-side connector 34 are connected to an in-device optical fiber 4. FIG. 1 shows an example in which the transmitting-side connector 14₁ and the receiving-side connector 34₁ are connected by an in-device optical fiber 4₁.

In the transmitter 1, couplers (multiplexers) 16₁, 16₂, . . . , 16ₙ are provided to the transmitting-side optical fibers 15₁, 15₂, . . . , 15ₙ.

A pluggable LD (Laser Diode) module (a connection check light source) 17 generates a check optical signal having a specific wavelength λₚ other than operational wavelengths.

A detection optical fiber 18 is provided to the pluggable LD module 17, and an end thereof is attachable and detachable to and from the couplers 16₁, 16₂, . . . , 16ₙ each other.

In the receiver 3, couplers (demultiplexers) 36₁, 36₂, . . . , 36ₙ are provided to the receiving-side optical fibers 35₁, 35₂, . . . , 35ₙ, respectively

Detection optical fibers 37₁, 37₂, . . . , 37ₙ are connected at their one ends to the couplers 36₁, 36₂, . . . , 36ₙ, respectively, and are connected at their other ends to an optical switch 38.

The optical switch (a switcher) 38 selects and outputs any one of check optical signals from the detection optical fibers 37₁, 37₂, . . . , 37ₙ.

An optical filter 39 removes a noise component of the check optical signal.

A level detector (an erroneous connection detector) 40 detects a level of the check optical signal and outputs a level signal in accordance with the detected level.

In the monitoring control package 9, an erroneous connection detector 91 compares the level signal with a preset threshold value. The monitoring control package 9 determines that the connection is normal when the level signal is greater than or equal to the threshold value, and determines that the connection is erroneous when the level signal is less than the threshold value.

Next, operation of Embodiment 1 will be described.

The optical demultiplexer 11 includes a wavelength selection switch (not depicted). The optical demultiplexer 11 demultiplexes a wavelength-multiplexed light coming from the input port 12 into light for each wavelength, and outputs the demultiplexed light from the output ports 13₁, 13₂, . . . , 13ₙ, which are arbitrarily set.

Also the optical multiplexer 31 includes a wavelength selection switch (not depicted). The optical multiplexer 31 multiplexes optical signals for each wavelength coming from the input ports 32₁, 32₂, . . . , 32ₙ, which are arbitrarily set, and outputs a wavelength-multiplexed light from the output port 33.

The in-device optical fiber 4 is connected to an arbitrary transmitting-side connector 14 and an arbitrary receiving-side connector 34. FIG. 1 represents an example in which, for example, the in-device optical fiber 4₁ is connected to the transmitting-side connector 14₁ and the receiving-side connector 34₁, based on a design drawing.

The Embodiment 1 is intended to detect whether the in-device optical fiber 4₁ is not erroneously connected and is connected to the right transmitting-side connector 14 and the right receiving-side connector 34.

In the transmitter 1 of FIG. 1, since the end of the detection optical fiber 18 of the pluggable LD module 17 is attachable and detachable to and from the couplers 16₁, 16₂, . . . , 16ₙ, the end of the detection optical fiber 18 is connected to the coupler 16₁.

In addition, in the receiver 3, the optical switch 38 is set to select and output a check optical signal from the detection optical fiber 37₁.

When the pluggable LD module 17 is activated, the pluggable LD module 17 generates a check optical signal having a specific wavelength λₚ other than operational wavelengths.

As shown in FIG. 1, the check optical signal passes through the detection optical fiber 18, the coupler 16₁, the transmitting-side optical fiber 15₁, the transmitting-side connector 14₁, the in-device optical fiber 4₁, the receiving-side connector 34₁, the receiving-side optical fiber 35₁, the coupler 36₁, the detection optical fiber 37₁, and the optical switch 38, and a noise component of the check optical signal is removed by the optical filter 39, and a level of the check optical signal is detected by the level detector 40.

A level signal generated by the level detector 40 is transmitted to the monitoring control package 9, and is compared with a preset threshold value by the erroneous connection detector 91.

When the level signal is greater than or equal to the threshold value, it is determined that the connection is normal. When the level signal is less than the threshold value, it is determined that the connection is erroneous.

In FIG. 1, since a path from the pluggable LD module 17 to the level detector 40 is closed, it is determined that the connection is normal.

On the other hand, when the in-device optical fiber 4₁ is connected, for instance, between the transmitting-side connector 14₁ and the receiving-side connector 34₂, a path from the pluggable LD module 17 to the level detector 40 is opened, and thus, it is determined that the connection is erroneous, i.e., the connection of the in-device optical fiber 4₁ is erroneous.

The above description describes a check operation for an example in which, as shown in FIG. 1, the in-device optical fiber 4₁ is connected to the transmitting-side connector 14₁ and the receiving-side connector 34₁ based on a design drawing.

Alternatively, assuming an example in which an in-device optical fiber 4₂ is connected to the transmitting-side connector 14₂ and the receiving-side connector 34₂ based on a design drawing, it is detected whether the in-device optical fiber 4₂ is connected to the right transmitting-side connector 14₂ and the right receiving-side connector 34₂ and is not erroneously connected. In this example, the detection can be achieved by connecting the end of the detection optical fiber 18 of the pluggable LD module 17 to the coupler 16₂ and allowing the optical switch 38 to select and output a check optical signal from the detection optical fiber 37₂.

Furthermore, assuming another example in which the in-device optical fiber 4₁ is connected to the transmitting-side connector 14₁ and the receiving-side connector 34₂ based on a design drawing, it is detected whether the in-device optical fiber 4₁ is connected to the right transmitting-side connector 14₁ and the right receiving-side connector 34₂ and is not erroneously connected. This detection can be achieved by connecting the end of the detection optical fiber 18 of the pluggable LD module 17 to the coupler 16₁ and allowing the optical switch 38 to select and output a check optical signal from the detection optical fiber 37₂.

As described above, according to the Embodiment 1, an erroneous connection of the in-device optical fiber 4₁ can be detected by only having the pluggable LD module 17, the detection optical fibers 18 and 37₁, 37₂, . . . , 37ₙ, the couplers 16₁, 16₂, . . . , 16ₙ and 36₁, 36₂, . . . , 36ₙ, the optical switch 38, the optical filter 39, the level detector 40, and the erroneous connection detector 91. Therefore, an erroneous connection of the in-device optical fiber 4 can be detected with a simple configuration in a case where a connection between a port of the transmitter 1 and a port of the receiver 3 is arbitrarily set.

In addition, since a check optical signal having a specific wavelength λₚ is transmitted without passing across the optical demultiplexer 11 and the optical multiplexer 31, a physical connection of the in-device optical fiber 4 can be checked regardless of the port settings of the wavelength selection switches included in the optical demultiplexer 11 and the optical multiplexer 31.

Furthermore, since the pluggable LD module 17 generates a check optical signal other than operational wavelengths, a check operation for the connected in-device optical fiber 4 can be performed without influencing on the operational wavelengths of other devices.

Moreover, since the pluggable LD module 17 allows the end of the detection optical fiber 18 to be attachable and detachable to and from the couplers 16₁, 16₂, . . . , 16ₙ, a check operation can be easily performed.

The pluggable LD module 17 and the detection optical fiber 18 are only used during a check operation, enabling to manufacture at low cost with a simpler configuration.

Furthermore, since the detection optical fibers 37₁, 37₂, . . . , 37ₙ are connected to the couplers 36₁, 36₂, . . . , 36ₙ, and a check optical signal is selected and output by the optical switch 38, a check operation can be easily performed.

In the receiver 3 of the above-described Embodiment 1, the detection optical fibers 37₁, 37₂, . . . , 37ₙ are connected to the couplers 36₁, 36₂, . . . , 36ₙ, and a check optical signal is selected and output by the optical switch 38.

Instead of this configuration, a detection optical fiber 37 whose one end is attachable and detachable may be provided to the couplers 36₁, 36₂, . . . , 36ₙ, and the other end of the detection optical fiber 37 may be connected to the optical filter 39. Furthermore, instead of selection by the optical switch 38, a selection is made as to which one of the couplers 36₁, 36₂, . . . , 36ₙ is to be connected to the one end of the detection optical fiber 37.

By employing these configurations, the optical switch 38 and the plurality of detection optical fibers 37₁, 37₂, . . . , 37ₙ become unnecessary, enabling to further simplify the configuration.

### Embodiment 2

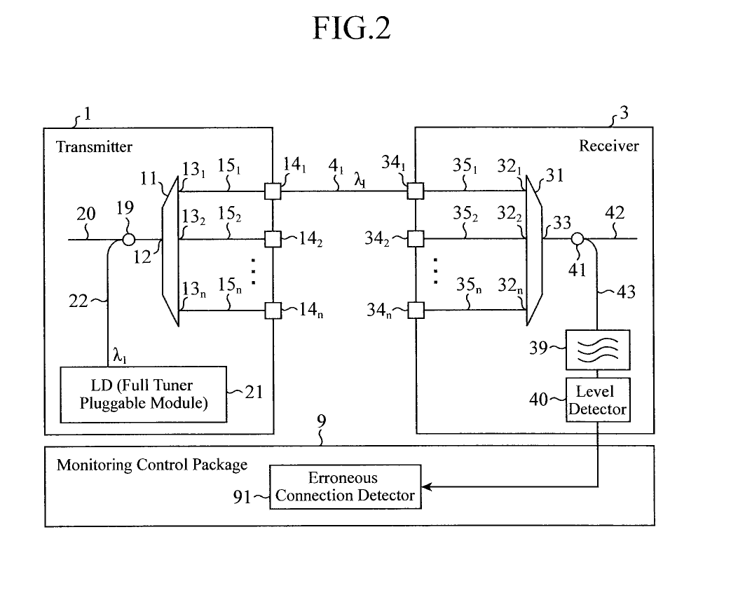

FIG. 2 is a circuit diagram depicting a wavelength multiplexing optical communication device according to Embodiment 2 of the present invention.

In a transmitter 1, a coupler (a multiplexer) 19 is provided to an optical fiber 20 which is connected to an input port 12 of an optical demultiplexer 11.

A full tuner pluggable LD module (a connection check light source) 21 selects an arbitrary wavelength from among operational wavelengths λ₁ to λₙ, and generates a check optical signal having the selected wavelength.

A detection optical fiber 22 is provided to the full tuner pluggable LD module 21, and an end thereof is attachable and detachable to and from the coupler 19.

In a receiver 3, a coupler (a demultiplexer) 41 is provided to an optical fiber 42 which is connected to an output port 33 of an optical multiplexer 31.

A detection optical fiber 43 is provided to an optical filter 39, and one end thereof is attachable and detachable to and from the coupler 41.

With regard to other configurations, the same ones as those of FIG. 1 are denoted by the same reference signs and overlapping description are omitted.

Next, operation of Embodiment 2 will be described.

FIG. 2 shows an example in which an in-device optical fiber 4₁ is connected to a transmitting-side connector 14₁ and a receiving-side connector 34₁ based on a design drawing.

In addition, a wavelength selection switch included in the optical demultiplexer 11 is set to demultiplex a wavelength-multiplexed light coming from the input port 12 into light for each wavelength and output an optical signal having a wavelength λ₁ from an output port 13₁.

Furthermore, a wavelength selection switch included in the optical multiplexer 31 is set to multiplex optical signals having the wavelength λ₁ coming from an input port 32₁ and output the wavelength-multiplexed light from the output port 33.

The Embodiment 2 is intended to detect whether the in-device optical fiber 4₁ is connected to the right transmitting-side connector 14 and the right receiving-side connector 34 and is not erroneously connected.

In addition, it is intended to detect whether the wavelength selection switch included in the optical demultiplexer 11 is set to demultiplex a wavelength-multiplexed light coming from the input port 12 and output an optical signal having a wavelength λ₁ from the output port 13₁, and further whether the wavelength selection switch included in the optical multiplexer 31 is set to multiplex optical signals having the wavelength λ₁ coming from the input port 32₁ and output the multiplexed optical signal from the output port 33.

In the transmitter 1 of FIG. 2, since the end of the detection optical fiber 22 of the full tuner pluggable LD module 21 is attachable and detachable to and from the coupler 19, the end of the detection optical fiber 22 is connected to the coupler 19.

In addition, in the receiver 3, since the end of the detection optical fiber 43 of the optical filter 39 is attachable and detachable to and from the coupler 41, the end of the detection optical fiber 43 is connected to the coupler 41.

The full tuner pluggable LD module 21 is activated to adjust to output a check optical signal having the same wavelength as the wavelength λ₁ of an optical signal as a check target from the output port 13₁.

As shown in FIG. 2, the check optical signal passes through the detection optical fiber 22, the coupler 19, the optical fiber 20, and the input port 12, and the check optical signal having the wavelength λ₁ is selected to be output from the output port 13₁ by the wavelength selection switch included in the optical demultiplexer 11.

In addition, the check optical signal passes through a transmitting-side optical fiber 15₁, the transmitting-side connector 14₁, the in-device optical fiber 4₁, the receiving-side connector 34₁, a receiving-side optical fiber 35₁, and the input port 32₁, and the check optical signal having the wavelength λ₁ coming from the input port 32₁ is selected to be output from the output port 33 by the wavelength selection switch included in the optical multiplexer 31.

Furthermore, the check optical signal passes through the optical fiber 42, the coupler 41, and the detection optical fiber 43, and a noise component of the check optical signal is removed by the optical filter 39, and a level of the check optical signal is detected by a level detector 40.

The level signal generated by the level detector 40 is transmitted to a monitoring control package 9, and is compared with a preset threshold value by an erroneous connection detector 91.

When the level signal is greater than or equal to the threshold value, it is determined that the connection is normal. When the level signal is less than the threshold value, it is determined that the connection is erroneous.

In FIG. 2, when the wavelength selection switch included in the optical demultiplexer 11 is set to demultiplex a wavelength-multiplexed light coming from the input port 12 and output an optical signal having a wavelength λ₁ from the output port 13₁, the in-device optical fiber 4₁ is connected to the transmitting-side connector 14₁ and the receiving-side connector 34₁, and the wavelength selection switch included in the optical multiplexer 31 is set to multiplex optical signals having the wavelength λ₁ coming from the input port 32₁ and output the multiplexed optical signal from the output port 33, a path from the full tuner pluggable LD module 21 to the level detector 40 is closed, and thus, it is determined that the connection is normal.

On the other hand, when there is an error in the setting of the wavelength selection switch included in the optical demultiplexer 11 or the optical multiplexer 31 or in the connection of the in-device optical fiber 4₁, a path from the full tuner pluggable LD module 21 to the level detector 40 is opened, and thus, it can be determined that the connection is erroneous.

The above description describes a check operation for an example in which, as shown in FIG. 2, the in-device optical fiber 4₁ is connected to the transmitting-side connector 14₁ and the receiving-side connector 34₁ based on a design drawing.

Alternatively, an example is assumed, in which, based on a design drawing, an in-device optical fiber 4₂ is connected to a transmitting-side connector 14₂ and a receiving-side connector 34₂, the wavelength selection switch included in the optical demultiplexer 11 is set to demultiplex a wavelength-multiplexed light coming from the input port 12 and output an optical signal having a wavelength λ₂ from an output port 13₂, and the wavelength selection switch included in the optical multiplexer 31 is set to multiplex optical signals having the wavelength λ₂ coming from an input port 32₂ and output the multiplexed optical signal from the output port 33. In this example, the connection of the in-device optical fiber 4₂ and the settings of the wavelength selection switches can be checked by outputting a check optical signal having the wavelength λ₂ from the full tuner pluggable LD module 21.

Consequently, by outputting, from the full tuner pluggable LD module 21, a check optical signal having the same wavelength as the wavelength λ of an optical signal coming from the output port 13 of the optical demultiplexer 11 to which the in-device optical fiber 4 as a check target is connected, the connection of the in-device optical fiber 4 as the check target and the settings of the wavelength selection switches can be checked.

As described above, according to the Embodiment 2, an erroneous connection of the in-device optical fiber 4₁ can be detected by only having the full tuner pluggable LD module 21, the detection optical fibers 22 and 43, the couplers 19 and 41, the optical filter 39, the level detector 40, and the erroneous connection detector 91. Therefore, an erroneous connection of the in-device optical fiber 4 can be detected with a simple configuration in a case where a connection between a port of the transmitter 1 and a port of the receiver 3 is arbitrarily set.

In addition, the settings of the wavelength selection switches included in the optical demultiplexer 11 and the optical multiplexer 31 can also be checked.

Furthermore, since the full tuner pluggable LD module 21 allows the end of the detection optical fiber 22 to be attachable and detachable to and from the coupler 19, a check operation can be easily performed.

In addition, the full tuner pluggable LD module 21 and the detection optical fiber 22 are only used during a check operation, enabling to manufacture at low cost with a simpler configuration.

Moreover, since the optical filter 39 allows the end of the detection optical fiber 43 to be attachable and detachable to and from the coupler 41, a check operation can be easily performed.

In addition, the optical filter 39, the detection optical fiber 43, the level detector 40, and the monitoring control package 9 are only used during a check operation, enabling to manufacture at low cost with a simpler configuration.

### Embodiment 3

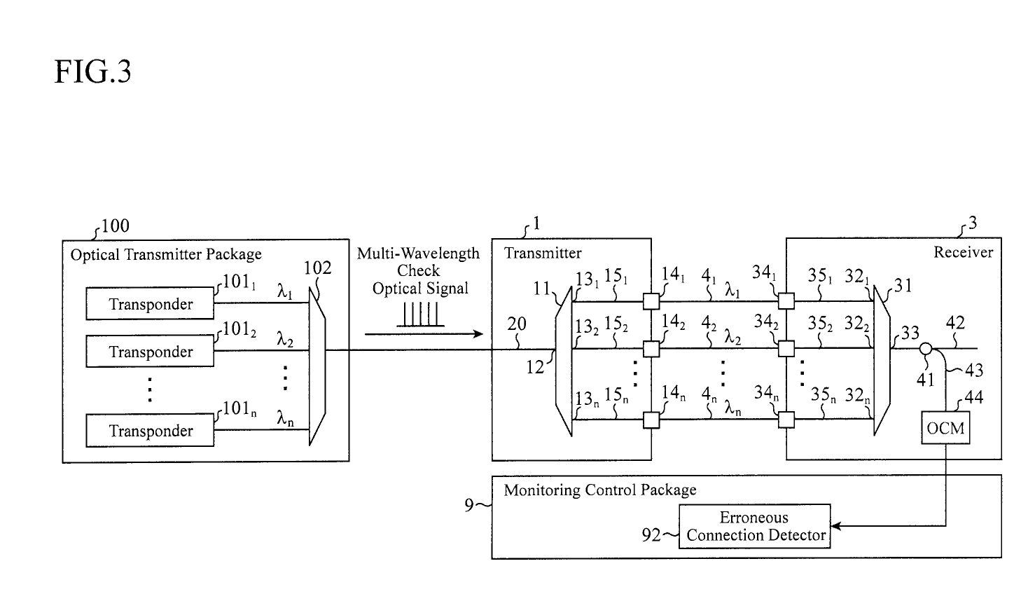

FIG. 3 is a circuit diagram depicting a wavelength multiplexing optical communication device according to Embodiment 3 of the present invention.

In the drawing, the wavelength multiplexing optical communication device includes a transmitter 1, a receiver 3, a monitoring control package 9, and an optical transmitter package (a multi-wavelength check optical signal supplier) 100.

In the optical transmitter package 100, transponders 101₁, 101₂, . . . , 101ₙ output optical signals having the same wavelengths as the wavelengths λ₁, λ₂, . . . , λₙ of optical signals from output ports 13₁, 13₂, . . . , 13ₙ of an optical demultiplexer 11.

An optical multiplexer 102 multiplexes the optical signals for each wavelength coming from the transponders 101₁, 101₂, . . . , 101ₙ and outputs the multiplexed optical signal to an optical fiber 20 as a multi-wavelength check optical signal.

In the receiver 3, an OCM (an Optical Channel Monitor; an erroneous connection detector) 44 separates the multi-wavelength check optical signal into signals for each of the wavelengths λ₁, λ₂, . . . , λₙ, detects levels for each wavelength, and outputs level signals for each wavelength.

A detection optical fiber 43 is provided to the OCM 44, and one end thereof is attachable and detachable to and from a coupler 41.

In the monitoring control package 9, an erroneous connection detector (an erroneous connection detector) 92 compares the level signals for each of the wavelengths λ₁, λ₂, . . . , λₙ with a preset threshold value. When the level signal is greater than or equal to the threshold value, the erroneous connection detector 92 further compares a wavelength whose level signal is greater than or equal to the threshold value with a preset wavelength. The erroneous connection detector 92 determines that the connection is normal when the wavelengths correspond to each other, and determines that the connection is erroneous when the wavelengths do not correspond to each other.

With regard to other configurations, the same ones as those of FIG. 1 are denoted by the same reference signs and overlapping description are omitted.

Next, operation of Embodiment 3 will be described.

FIG. 3 shows an example in which in-device optical fibers 4₁, 4₂, . . . , 4ₙ are connected to transmitting-side connectors 14₁, 14₂, . . . , 14ₙ and receiving-side connectors 34₁, 34₂, . . . , 34ₙ, respectively, based on a design drawing.

In addition, a wavelength selection switch included in the optical demultiplexer 11 is set to demultiplex a wavelength-multiplexed light coming from an input port 12 into light for each wavelength and output optical signals having wavelengths λ₁, λ₂, . . . , λₙ from the output ports 13₁, 13₂, . . . , 13ₙ.

Furthermore, a wavelength selection switch included in an optical multiplexer 31 is set to multiplex the optical signals having the wavelengths λ₁, λ₂, . . . , λₙ from input ports 32₁, 32₂, . . . , 32ₙ, and output a wavelength-multiplexed light from an output port 33.

The Embodiment 3 is intended to detect whether the in-device optical fibers 4₁, 4₂, . . . , 4ₙ are connected to the right transmitting-side connectors 14 and the right receiving-side connectors 34 and are not erroneously connected.

In addition, it is intended to detect whether the wavelength selection switches included in the optical demultiplexer 11 and the optical multiplexer 31 are correctly set.

The optical transmitter package 100 shown in FIG. 3 is a package having the transponders 101₁, 101₂, . . . , 101ₙ of a client interface unit that transmits operational wavelengths. Optical signals having wavelengths λ₁, λ₂, . . . , λₙ are output from the transponders 101₁, 101₂, . . . , 101ₙ and multiplexed by the optical multiplexer 102 provided at a stage subsequent to the transponders, and then are output to the optical fiber 20 as a multi-wavelength check optical signal.

As shown in FIG. 3, the multi-wavelength check optical signal coming from the input port 12 is demultiplexed by the wavelength selection switch included in the optical demultiplexer 11 into optical signals having the wavelengths λ₁, λ₂, . . . , λₙ. The output signals having the wavelengths λ₁, λ₂, . . . , λₙ are output from the output ports 13₁, 13₂, . . . , 13ₙ, respectively.

In addition, the optical signals having the wavelengths λ₁, λ₂, . . . , λₙ pass through transmitting-side optical fibers 15₁, 15₂, . . . , 15ₙ, respectively, the transmitting-side connectors 14₁, 14₂, . . . , 14ₙ, the in-device optical fibers 4₁, 4₂, . . . , 4ₙ, the receiving-side connectors 34₁, 34₂, . . . , 34ₙ, receiving-side optical fibers 35₁, 35₂, . . . , 35ₙ, and the input ports 32₁, 32₂, . . . , 32ₙ, and the optical signals having the wavelengths λ₁, λ₂, . . . , λₙ coming from the input ports 32₁, 32₂, . . . , 32ₙ are selected to be multiplexed to output a multi-wavelength check optical signal from the output port 33 by the wavelength selection switch included in the optical multiplexer 31.

Furthermore, the multi-wavelength check optical signal passes through an optical fiber 42, the coupler 41, and the detection optical fiber 43, and is separated by the OCM 44 into signals for each of the wavelengths λ₁, λ₂, . . . , λₙ, and levels for each of the separated wavelengths is detected. The detected levels for each wavelength are output as level signals for each wavelength.

The level signals for each of the wavelengths λ₁, λ₂, . . . , λₙ generated by the OCM 44 are transmitted to the monitoring control package 9. The erroneous connection detector 92 compares the level signals for each of the wavelengths λ₁, λ₂, . . . , λₙ with a preset threshold value. The erroneous connection detector 92 further compares a wavelength whose level signal is greater than or equal to the threshold value with a preset wavelength, in which case the wavelengths λ₁, λ₂, . . . , λₙ. The erroneous connection detector 92 determines that the connection is normal when the wavelengths correspond to each other, and determines that the connection is erroneous when the wavelengths do not correspond to each other.

In FIG. 3, when the wavelength selection switch included in the optical demultiplexer 11 is set to demultiplex a wavelength-multiplexed light coming from the input port 12 and output optical signals having wavelengths λ₁, λ₂, . . . , λₙ from the output ports 13₁, 13₂, . . . , 13ₙ, the in-device optical fibers 4₁, 4₂, . . . , 4ₙ are connected to the transmitting-side connectors 14₁, 14₂, . . . , 14ₙ and the receiving-side connectors 34₁, 34₂, . . . , 34ₙ, and the wavelength selection switch included in the optical multiplexer 31 is set to multiplex the optical signals having the wavelengths λ₁, λ₂, . . . , λₙ coming from the input ports 32₁, 32₂, . . . , 32ₙ and output the multiplexed optical signal from the output port 33, a path from the optical transmitter package 100 to the OCM 44 is closed, and thus, it is determined that the connection is normal.

On the other hand, when there is an error in the setting of the wavelength selection switch included in the optical demultiplexer 11 or the optical multiplexer 31 or in the connections of the in-device optical fibers 4₁, 4₂, . . . , 4ₙ, a path from the optical transmitter package 100 to the OCM 44 is opened, and thus, it can be determined that the connection is erroneous.

Consequently, by outputting, from the optical transmitter package 100, a multi-wavelength check optical signal having the same wavelengths as the wavelengths λ of optical signals coming from the output ports 13 of the optical demultiplexer 11 to which the in-device optical fibers 4 as check targets are connected, the connections of the in-device optical fibers 4 as the check targets and the settings of the wavelength selection switches can be checked.

As described above, according to the Embodiment 3, erroneous connections of the in-device optical fibers 4₁, 4₂, . . . , 4ₙ can be detected only by including the optical transmitter package 100, the OCM 44, and the erroneous connection detector 92. Therefore, erroneous connections of the in-device optical fibers 4 can be detected with a simple configuration in a case where a connection between a port of the transmitter 1 and a port of the receiver 3 is arbitrarily set.

In addition, the settings of the wavelength selection switches included in the optical demultiplexer 11 and the optical multiplexer 31 can also be checked.

Furthermore, since a plurality of wavelengths can be checked at a time by the optical transmitter package 100, the OCM 44, and the erroneous connection detector 92, a check operation can be efficiently performed.

Moreover, since the OCM 44 allows the end of the detection optical fiber 43 to be attachable and detachable to and from the coupler 41, a check operation can be easily performed.

In addition, the detection optical fiber 43, the OCM 44, and the monitoring control package 9 are only used during a check operation, enabling to manufacture at low cost with a simpler configuration.

### Embodiment 4

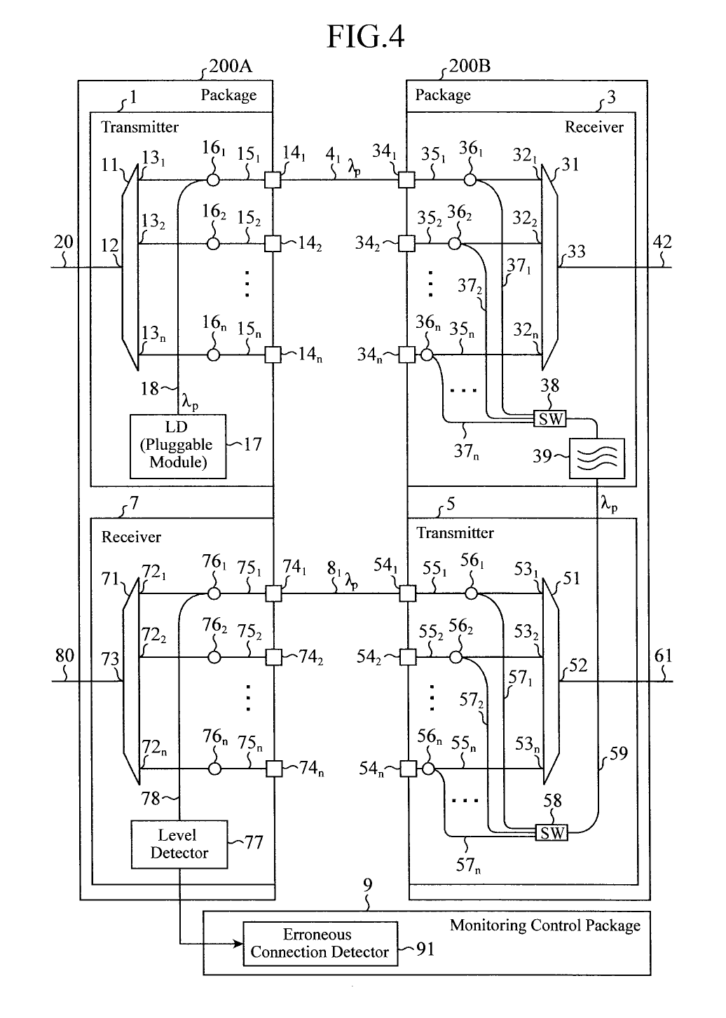

FIG. 4 is a circuit diagram depicting a wavelength multiplexing optical communication device according to Embodiment 4 of the present invention.

In the drawing, the wavelength multiplexing optical communication device includes packages 200A and 200B, and a monitoring control package 9.

The package 200A includes a transmitter 1 and a receiver 7, and the package 200B includes a receiver 3 and a transmitter 5.

In the transmitter 5 of the package 200B, an optical demultiplexer 51 demultiplexes a wavelength-multiplexed light coming from an input port 52 into light for each wavelength, and outputs the demultiplexed light from output ports 53₁, 53₂, . . . , 53ₙ.

Transmitting-side connectors 54₁, 54₂, . . . , 54ₙ are provided in correspondence with the output ports 53₁, 53₂, . . . , 53ₙ of the optical demultiplexer 51, respectively.

Transmitting-side optical fibers 55₁, 55₂, . . . , 55ₙ connect the output ports 53₁, 53₂, . . . , 53ₙ of the optical demultiplexer 51 to the transmitting-side connectors 54₁, 54₂, . . . , 54ₙ provided in correspondence with the output ports 53₁, 53₂, . . . , 53ₙ, respectively.

In the receiver 7 of the package 200A, an optical multiplexer 71 multiplexes optical signals for each wavelength coming from input ports 72₁, 72₂, . . . , 72ₙ and outputs the wavelength-multiplexed light from an output port 73.

Receiving-side connectors 74₁, 74₂, . . . , 74ₙ are provided in correspondence with the input ports 72₁, 72₂, . . . , 72ₙ of the optical multiplexer 71, respectively.

Receiving-side optical fibers 75₁, 75₂, . . . , 75ₙ connect the input ports 72₁, 72₂, . . . , 72ₙ of the optical multiplexer 71 to the receiving-side connectors 74₁, 74₂, . . . , 74ₙ provided in correspondence with the input ports 72₁, 72₂, . . . , 72ₙ, respectively.

An arbitrary transmitting-side connector 54 and an arbitrary receiving-side connector 74 are connected to an in-device optical fiber 8. FIG. 4 shows an example in which the transmitting-side connector 54₁ and the receiving-side connector 74₁ are connected by an in-device optical fiber 8₁.

In the transmitter 5 of the package 200B, couplers (second multiplexers) 56₁, 56₂, . . . , 56ₙ are provided to the transmitting-side optical fibers 55₁, 55₂, . . . , 55ₙ, respectively.

Detection optical fibers 57₁, 57₂, . . . , 57ₙ are connected at their one ends to the couplers 56₁, 56₂, . . . , 56ₙ, respectively, and are connected at their other ends to an optical switch 58.

A detection optical fiber 59 is connected to an output terminal of an optical filter 39 and an input terminal of the optical switch 58.

The optical switch (a switcher) 58 selects one of the detection optical fibers 57₁, 57₂, . . . , 57ₙ to output a check optical signal having passed through the optical filter 39.

In the receiver 7 of the package 200A, couplers (second demultiplexers) 76₁, 76₂, . . . , 76ₙ are provided to the receiving-side optical fibers 75₁, 75₂, . . . , 75ₙ, respectively.

A level detector (an erroneous connection detector) 77 detects a level of the check optical signal and outputs a level signal in accordance with the detected level.

A detection optical fiber 78 is provided to the level detector 77, and one end thereof is attachable and detachable to and from the couplers 76₁, 76₂, . . . , 76ₙ.

With regard to other configurations, the same ones as those of FIG. 1 are denoted by the same reference signs and overlapping description is omitted.

Next, operation of Embodiment 4 will be described.

In the above-described Embodiment 1, only the connection between a transmitter 1 and a receiver 3 is checked. In the present Embodiment 4, a reciprocal connection is checked by adding the connection between the transmitter 5 and the receiver 7 to the connection between the transmitter 1 and the receiver 3.

FIG. 4 shows an example, based on a design drawing, in which an in-device optical fiber 4₁ is connected to a transmitting-side connector 14₁ and a receiving-side connector 34₁, while the in-device optical fiber 8₁ is connected to the transmitting-side connector 54₁ and the receiving-side connector 74₁.

The Embodiment 4 is intended to detect whether the in-device optical fiber 4₁ is connected to the right transmitting-side connector 14 and the right receiving-side connector 34, and whether the in-device optical fiber 8₁ is connected to the right transmitting-side connector 54 and the right receiving-side connector 74, and then whether the in-device optical fibers 4₁ and 8₁ are not erroneously connected.

In the transmitter 1 of FIG. 4, since an end of a detection optical fiber 18 of a pluggable LD module 17 is attachable and detachable to and from couplers 16₁, 16₂, . . . , 16ₙ, the end of the detection optical fiber 18 is connected to the coupler 16₁.

In the receiver 3, an optical switch 38 is set to select and output a check optical signal from a detection optical fiber 37₁.

In the transmitter 5, the optical switch 58 is set to output the check optical signal to the detection optical fiber 57₁.

Since the end of the detection optical fiber 78 of the level detector 77 is attachable and detachable to and from the couplers 76₁, 76₂, . . . , 76ₙ, the end of the detection optical fiber 78 is connected to the coupler 76₁.

When the pluggable LD module 17 is activated, the pluggable LD module 17 generates a check optical signal having a specific wavelength λₚ other than operational wavelengths.

As shown in FIG. 4, the check optical signal passes through the detection optical fiber 18, the coupler 16₁, a transmitting-side optical fiber 15₁, the transmitting-side connector 14₁, the in-device optical fiber 4₁, the receiving-side connector 34₁, a receiving-side optical fiber 35₁, a coupler 36₁, the detection optical fiber 37₁, and the optical switch 38, and a noise component of the check optical signal is removed by the optical filter 39.

The check optical signal, whose noise component has been removed, passes through the detection optical fiber 59, the optical switch 58, the detection optical fiber 57₁, the coupler 56₁, the transmitting-side optical fiber 55₁, the transmitting-side connector 54₁, the in-device optical fiber 8₁, the receiving-side connector 74₁, the receiving-side optical fiber 75₁, the coupler 76₁, and the detection optical fiber 78, and a level of the check optical signal is detected by the level detector 77.

A level signal generated by the level detector 77 is transmitted to the monitoring control package 9, and is compared with a preset threshold value by an erroneous connection detector 91.

When the level signal is greater than or equal to the threshold value, it is determined that the connection is normal. When the level signal is less than the threshold value, it is determined that the connection is erroneous.

In FIG. 4, since a path from the pluggable LD module 17 to the level detector 77 is closed, it is determined that the connection is normal.

On the other hand, when the in-device optical fiber 4₁ is connected between the transmitting-side connector 14₁ and a receiving-side connector 34₂, or the in-device optical fiber 8₁ is connected between a transmitting-side connector 54₃ and the receiving-side connector 74₁, a path from the pluggable LD module 17 to the level detector 77 is opened, and thus, it can be determined that the connection is erroneous, i.e., the connection of the in-device optical fiber 4₁ or the in-device optical fiber 8₁ is erroneous.

As described above, according to the Embodiment 4, erroneous connections of the in-device optical fibers 4₁ and 8₁ can be detected only by including the pluggable LD module 17, the detection optical fibers 18, 37₁, 37₂, . . . , 37ₙ, 57₁, 57₂, . . . , 57ₙ, and 78, the couplers 16₁, 16₂, . . . , 16ₙ, 36₁, 36₂, . . . , 36ₙ, 56₁, 56₂, . . . , and 56ₙ, and 76₁, 76₂, . . . , 76ₙ, the optical switches 38 and 58, the optical filter 39, the level detector 77, and the erroneous connection detector 91. Therefore, erroneous connections of the in-device optical fibers 4 and 8 can be detected with a simple configuration in a case where each connection between the transmitters 1 and 5 and the ports of the receivers 3 and 7, respectively, is arbitrarily set.

In addition, since a check optical signal having a specific wavelength λₚ is transmitted without passing across the optical demultiplexers 11 and 51 and the optical multiplexers 31 and 71, physical connections of the in-device optical fibers 4 and 8 can be checked regardless of the port settings of the wavelength selection switches included in the optical demultiplexers 11 and 51 and the optical multiplexers 31 and 71.

Furthermore, by adding the connection of the in-device optical fiber 8 between the transmitter 5 and the receiver 7 to the connection of the in-device optical fiber 4 between the transmitter 1 and the receiver 3, a reciprocal connection can be checked at a time.

Moreover, since the detection optical fibers 37₁, 37₂, . . . , 37ₙ are connected to the couplers 36₁, 36₂, . . . , 36ₙ, respectively, and a check optical signal is selected and output by the optical switch 38, and the detection optical fibers 57₁, 57₂, . . . , 57ₙ are connected to the couplers 56₁, 56₂, . . . , 56ₙ, and an output of the check optical signal is selected by the optical switch 58, a check operation can be easily performed.

In the above-described Embodiment 4, in the receiver 3, the detection optical fibers 37₁, 37₂, . . . , 37ₙ are connected to the couplers 36₁, 36₂, . . . , 36ₙ, and a check optical signal is selected and output by the optical switch 38, and the detection optical fibers 57₁, 57₂, . . . , 57ₙ are connected to the couplers 56₁, 56₂, . . . , 56ₙ, and an output of the check optical signal is selected by the optical switch 58.

Alternatively, a detection optical fiber 37 whose one end is attachable and detachable may be provided to the couplers 36₁, 36₂, . . . , 36ₙ, and the other end of the detection optical fiber 37 may be connected to an input terminal of the optical filter 39, and a detection optical fiber 57 whose one end is attachable and detachable may be provided to the couplers 56₁, 56₂, . . . , 56ₙ, and the other end of the detection optical fiber 57 may be connected to the output terminal of the optical filter 39. Instead of selections by the optical switches 38 and 58, selections are made as to which one of the couplers 36₁, 36₂, . . . , 36ₙ is to be connected to the one end of the detection optical fiber 37, and which one of the couplers 56₁, 56₂, . . . , 56ₙ is to be connected to the one end of the detection optical fiber 57.

In this case, the optical switches 38 and 58 and the plurality of detection optical fibers 37₁, 37₂, . . . , 37ₙ and 57₁, 57₂, . . . , 57ₙ become unnecessary, enabling to further simplify the configuration.

### Embodiment 5

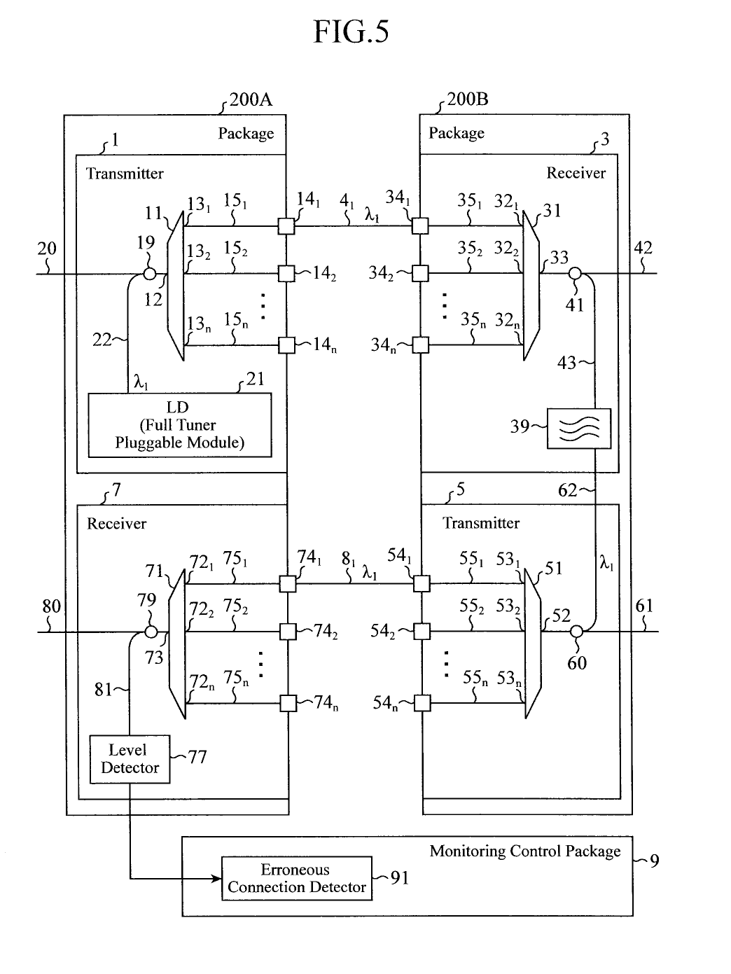

FIG. 5 is a circuit diagram depicting a wavelength multiplexing optical communication device according to Embodiment 5 of the present invention.

In a transmitter 5 of a package 200B, a coupler (a second multiplexer) 60 is provided to an optical fiber 61 which is connected to an input port 52 of an optical demultiplexer 51.

A detection optical fiber 62 is provided to an output terminal of an optical filter 39, and one end thereof is attachable and detachable to and from the coupler 60.

In a receiver 7 of a package 200A, a coupler (a first demultiplexer) 79 is provided to an optical fiber 80 which is connected to an output port 73 of an optical multiplexer 71.

A detection optical fiber 81 is provided to a level detector 77, and one end thereof is attachable and detachable to and from the coupler 79.

With regard to other configurations, the same ones as those of FIG. 4 are denoted by the same reference signs and overlapping description is omitted.

Next, operation of Embodiment 5 will be described.

In the above-described Embodiment 2, only the connection between a transmitter 1 and a receiver 3 is checked. In the present Embodiment 5, a reciprocal connection is checked by adding the connection between the transmitter 5 and the receiver 7 to the connection between a transmitter 1 and a receiver 3.

FIG. 5 shows an example, based on a design drawing, in which an in-device optical fiber 4₁ is connected to a transmitting-side connector 14₁ and a receiving-side connector 34₁, while an in-device optical fiber 8₁ is connected to a transmitting-side connector 54₁ and a receiving-side connector 74₁.

A wavelength selection switch included in an optical demultiplexer 11 is set to demultiplex a wavelength-multiplexed light coming from an input port 12 into light for each wavelength, and output an optical signal having a wavelength λ₁ from an output port 13₁.

A wavelength selection switch included in an optical multiplexer 31 is set to multiplex optical signals having the wavelength λ₁ coming from an input port 32₁, and output the wavelength-multiplexed light from an output port 33.

A wavelength selection switch included in the optical demultiplexer 51 is set to demultiplex the wavelength-multiplexed light coming from the input port 52 for each wavelength, and output an optical signal having the wavelength λ₁ from an output port 53₁.

A wavelength selection switch included in the optical multiplexer 71 is set to multiplex optical signals having the wavelength λ₁ coming from an input port 72₁, and output the wavelength-multiplexed light from the output port 73.

The Embodiment 5 is intended to detect whether the in-device optical fiber 4₁ is connected to the right transmitting-side connector 14 and the right receiving-side connector 34, and whether the in-device optical fiber 8₁ is connected to the right transmitting-side connector 54 and the right receiving-side connector 74, and then whether the in-device optical fibers 4₁ and 8₁ are not erroneously connected.

In addition, it is intended to detect whether the wavelength selection switch included in the optical demultiplexer 11 is set to demultiplex a wavelength-multiplexed light coming from the input port 12 and output an optical signal having a wavelength λ₁ from the output port 13₁, and whether the wavelength selection switch included in the optical multiplexer 31 is set to multiplex optical signals having the wavelength λ₁ coming from the input port 32₁ and output the multiplexed optical signal from the output port 33, and whether the wavelength selection switch included in the optical demultiplexer 51 is set to demultiplex a wavelength-multiplexed light coming from the input port 52 and output an optical signal having the wavelength λ₁ from the output port 53₁, and whether the wavelength selection switch included in the optical multiplexer 71 is set to multiplex optical signals having the wavelength λ₁ coming from the input port 72₁ and output the multiplexed optical signal from the output port 73.

In the transmitter 1 of FIG. 5, since an end of a detection optical fiber 22 of a full tuner pluggable LD module 21 is attachable and detachable to and from a coupler 19, the end of the detection optical fiber 22 is connected to the coupler 19.

In the receiver 3, since an end of a detection optical fiber 43 of the optical filter 39 is attachable and detachable to and from a coupler 41, the end of the detection optical fiber 43 is connected to the coupler 41.

In the transmitter 5, since an end of the detection optical fiber 62 of the optical filter 39 is attachable and detachable to and from the coupler 60, the end of the detection optical fiber 62 is connected to the coupler 60.

In the receiver 7, since an end of the detection optical fiber 81 of the level detector 77 is attachable and detachable to and from the coupler 79, the end of the detection optical fiber 81 is connected to the coupler 79.

The full tuner pluggable LD module 21 is activated to adjust to output a check optical signal having the same wavelength as the wavelength λ₁ of an optical signal from the output port 13₁ as a check target.

As shown in FIG. 5, the check optical signal passes through the detection optical fiber 22, the coupler 19, an optical fiber 20, and the input port 12, and the check optical signal having the wavelength λ₁ is selected to be output from the output port 13₁ by the wavelength selection switch included in the optical demultiplexer 11.

The check optical signal having the wavelength λ₁ passes through a transmitting-side optical fiber 15₁, the transmitting-side connector 14₁, the in-device optical fiber 4₁, the receiving-side connector 34₁, a receiving-side optical fiber 35₁, and the input port 32₁ and the check optical signal having the wavelength λ₁ coming from the input port 32₁ is selected to be output from the output port 33 by the wavelength selection switch included in the optical multiplexer 31.

The check optical signal having the wavelength λ₁ passes through an optical fiber 42, the coupler 41 and the detection optical fiber 43, and a noise component of the check optical signal is removed by the optical filter 39.

The check optical signal whose noise component has been removed passes through the detection optical fiber 62, the coupler 60, the optical fiber 61 and the input port 52, and the check optical signal having the wavelength λ₁ is selected to be output from the output port 53₁ by the wavelength selection switch included in the optical demultiplexer 51.

The check optical signal having the wavelength λ₁ passes through a transmitting-side optical fiber 55₁, the transmitting-side connector 54₁, the in-device optical fiber 8₁, the receiving-side connector 74₁, a receiving-side optical fiber 75₁ and the input port 72₁, and the check optical signal having the wavelength λ₁ coming from the input port 72₁ is selected to be output from the output port 73 by the wavelength selection switch included in the optical multiplexer 71. The check optical signal having the wavelength λ₁ passes through the optical fiber 80, the coupler 79 and the detection optical fiber 81, and a level of the check optical signal is detected by the level detector 77.

A level signal generated by the level detector 77 is transmitted to a monitoring control package 9, and is compared with a preset threshold value by an erroneous connection detector 91.

When the level signal is greater than or equal to the threshold value, it is determined that the connection is normal. When the level signal is less than the threshold value, it is determined that the connection is erroneous.

In FIG. 5, since the wavelength selection switch included in the optical demultiplexer 11 is set to demultiplex a wavelength-multiplexed light coming from the input port 12 and output an optical signal having a wavelength λ₁ from the output port 13₁, the in-device optical fiber 4₁ is connected to the transmitting-side connector 14₁ and the receiving-side connector 34₁, and the wavelength selection switch included in the optical multiplexer 31 is set to multiplex optical signals having the wavelength λ₁ coming from the input port 32₁ and output the multiplexed optical signal from the output port 33, and furthermore, the wavelength selection switch included in the optical demultiplexer 51 is set to demultiplex a wavelength-multiplexed light coming from the input port 52 and output an optical signal having the wavelength λ₁ from the output port 53₁, the in-device optical fiber 8₁ is connected to the transmitting-side connector 54₁ and the receiving-side connector 74₁, and the wavelength selection switch included in the optical multiplexer 71 is set to multiplex optical signals having the wavelength λ₁ coming from the input port 72₁ and output the multiplexed optical signal from the output port 73, a path from the full tuner pluggable LD module 21 to the level detector 77 is closed, and thus, it is determined that the connection is normal.

On the other hand, when there is an error in the setting of the wavelength selection switch included in the optical demultiplexer 11 or 51 or the optical multiplexer 31 or 71 or in the connection of the in-device optical fiber 4₁ or 8₁, a path from the full tuner pluggable LD module 21 to the level detector 77 is opened, and thus, it can be determined that the connection is erroneous.

As described above, according to the Embodiment 5, erroneous connections of the in-device optical fibers 4₁ and 8₁ can be detected only by including the full tuner pluggable LD module 21, the detection optical fibers 22, 43, 62, and 81, the couplers 19, 41, 60, and 79, the optical filter 39, the level detector 77 and the erroneous connection detector 91. Therefore, erroneous connections of the in-device optical fibers 4 and 8 can be detected with a simple configuration in a case where each connection between the ports of the transmitters 1 and 5 and the ports of the receivers 3 and 7, respectively, are arbitrarily set.

In addition, the settings of the wavelength selection switches included in the optical demultiplexers 11 and 51 and the optical multiplexers 31 and 71 can also be checked.

Furthermore, by adding the connection of the in-device optical fiber 8 between the transmitter 5 and the receiver 7 to the connection of the in-device optical fiber 4 between the transmitter 1 and the receiver 3, a reciprocal connection can be checked at a time.

Moreover, since the optical filter 39 allows the end of the detection optical fiber 43 to be attachable and detachable to and from the coupler 41, and allows the end of the detection optical fiber 62 to be attachable and detachable to and from the coupler 60, a check operation can be easily performed.

In addition, the optical filter 39, the detection optical fibers 43, 62, and 81, the level detector 77, and the monitoring control package 9 are only used during a check operation, enabling to manufacture at low cost with a simpler configuration.

In the invention of the present application, free combinations of the embodiments or modifications to any component in the embodiments or omission of any component in the embodiments are possible within the scope of the invention.

Each of the wavelength multiplexing optical communication devices according to the present invention include a connection check light source, a multiplexer, a demultiplexer, and an erroneous connection detector, and can detect an erroneous connection of an optical fiber, with a simple configuration. Therefore, the wavelength multiplexing optical communication devices are suitable to be used as wavelength multiplexing optical communication devices that detect an erroneous connection of an in-device optical fiber where the points where a port of a transmitter and a port of a receiver are connected to each other are arbitrarily set.

1: A wavelength multiplexing optical communication device including a transmitter and a receiver,
the transmitter having: an optical demultiplexer that demultiplexes a wavelength-multiplexed light coming from an input port into light for each wavelength and outputs the demultiplexed light from individual output ports; transmitting-side connectors that is provided in correspondence with the output ports of the optical demultiplexer; and transmitting-side optical fibers that connect the output ports of the optical demultiplexer to the transmitting-side connectors provided in correspondence with the output ports,
the receiver having: an optical multiplexer that multiplexes optical signals for each wavelength coming from a plurality of input ports and outputs the wavelength-multiplexed light from an output port; receiving-side connectors that is provided in correspondence with the input ports of the optical multiplexer; and receiving-side optical fibers that connect the input ports of the optical multiplexer to the receiving-side connectors provided in correspondence with the input ports,
the transmitting-side connectors and the receiving-side connectors being connected by an in-device optical fiber,
the wavelength multiplexing optical communication device comprising:
a connection check light source that generates a check optical signal;
a multiplexer that multiplexes the check optical signal onto the transmitting-side optical fiber which links the transmitting-side connector with a corresponding output port of the optical demultiplexer, the transmitting-side connector being connected to the in-device optical fiber;
a demultiplexer that demultiplexes the check optical signal from a receiving-side optical fiber which links the receiving-side connector with a corresponding input port of the optical multiplexer, the receiving-side connector being connected to the in-device optical fiber; and
an erroneous connection detector that detects a level of the check optical signal obtained by the demultiplexer and detects an erroneous connection of the in-device optical fiber in accordance with the detected level.

2: A wavelength multiplexing optical communication device including a transmitter and a receiver,
the transmitter having: an optical demultiplexer that demultiplexes a wavelength-multiplexed light coming from an input port into light for each wavelength and outputs the demultiplexed light from individual output ports; transmitting-side connectors that is provided in correspondence with the output ports of the optical demultiplexer; and transmitting-side optical fibers that connect the output ports of the optical demultiplexer to the transmitting-side connectors provided in correspondence with the output ports,
the receiver having: an optical multiplexer that multiplexes optical signals for each wavelength coming from a plurality of input ports and outputs the wavelength-multiplexed light from an output port; receiving-side connectors that is provided in correspondence with the input ports of the optical multiplexer; and receiving-side optical fibers that connect the input ports of the optical multiplexer to the receiving-side connectors provided in correspondence with the input ports,
the transmitting-side connectors and the receiving-side connectors being connected by an in-device optical fiber,
the wavelength multiplexing optical communication device comprising:
a connection check light source that generates a check optical signal which has a same wavelength as a wavelength of an optical signal coming from an output port of the optical demultiplexer provided in correspondence with the transmitting-side connector to which the in-device optical fiber is connected;
a multiplexer that multiplexes the check optical signal of the connection check light source onto the input port of the optical demultiplexer;
a demultiplexer that demultiplexes the check optical signal from the output port of the optical multiplexer; and
an erroneous connection detector that detects a level of the check optical signal obtained by the demultiplexer and detects an erroneous connection of the in-device optical fiber in accordance with the detected level.

3: A wavelength multiplexing optical communication device including a transmitter and a receiver,
the transmitter having: an optical demultiplexer that demultiplexes a wavelength-multiplexed light coming from an input port into light for each wavelength and outputs the demultiplexed light from individual output ports; transmitting-side connectors that is provided in correspondence with the output ports of the optical demultiplexer; and transmitting-side optical fibers that connect the output ports of the optical demultiplexer to the transmitting-side connectors provided in correspondence with the output ports,
the receiver having: an optical multiplexer that multiplexes optical signals for each wavelength coming from a plurality of input ports and outputs the wavelength-multiplexed light from an output port; receiving-side connectors that is provided in correspondence with the input ports of the optical multiplexer; and receiving-side optical fibers that connect the input ports of the optical multiplexer to the receiving-side connectors provided in correspondence with the input ports,
the transmitting-side connectors and the receiving-side connectors being connected by an in-device optical fiber,
the wavelength multiplexing optical communication device comprising:
a multi-wavelength check optical signal supplier that generates a multi-wavelength check optical signal which has same wavelengths as wavelengths of optical signals from the output ports of the optical demultiplexer provided in correspondence with the transmitting-side connectors to which the in-device optical fibers are connected, and supplies the multi-wavelength check optical signal to the input port of the optical demultiplexer;
a demultiplexer that demultiplexes the multi-wavelength check optical signal from the output port of the optical multiplexer; and
an erroneous connection detector that detects, for each wavelength, levels of the multi-wavelength check optical signal obtained by the demultiplexer, and detects erroneous connections of the in-device optical fibers in accordance with the detected levels for each wavelength.

4: The wavelength multiplexing optical communication device according to claim 1, further comprising a second transmitter, a second receiver, a second multiplexer, and a second demultiplexer, each of which has an structure equivalent to the transmitter, the receiver, the multiplexer, and the demultiplexer, respectively, wherein
the second transmitter and the second receiver are connected with each other through a second in-device optical fiber,
the second multiplexer multiplexes the check optical signals obtained by the demultiplexer, and
the erroneous connection detector detects a level of a check optical signal obtained by the second demultiplexer instead of the level of the check optical signal obtained by the demultiplexer and detects an erroneous connection of the in-device optical fiber and the second in-device optical fiber in accordance with the detected level.

5: The wavelength multiplexing optical communication device according to claim 2, further comprising a second transmitter, a second receiver, a second multiplexer, and a second demultiplexer, each of which has an structure equivalent to the transmitter, the receiver, the multiplexer, and the demultiplexer, respectively, wherein
the second transmitter and the second receiver are connected with each other through a second in-device optical fiber,
the second multiplexer multiplexes the check optical signals obtained by the demultiplexer, and
the erroneous connection detector detects a level of a check optical signal obtained by the second demultiplexer instead of the level of the check optical signal obtained by the demultiplexer and detects an erroneous connection of the in-device optical fiber and the second in-device optical fiber in accordance with the detected level.

6: The wavelength multiplexing optical communication device according to claim 1, wherein the connection check light source generates a check optical signal having a wavelength other than operational wavelengths.

7: The wavelength multiplexing optical communication device according to claim 4, wherein the connection check light source generates a check optical signal having a wavelength other than operational wavelengths.

8: The wavelength multiplexing optical communication device according to claim 1, wherein the connection check light source and the multiplexer are attachable and detachable each other.

9: The wavelength multiplexing optical communication device according to claim 4, wherein the connection check light source and the multiplexer are attachable and detachable each other.

10: The wavelength multiplexing optical communication device according to claim 4, wherein the second demultiplexer and the erroneous connection detector are attachable and detachable each other.

11: The wavelength multiplexing optical communication device according to claim 1, wherein the demultiplexer is individually provided to the receiving-side optical fibers, and is made shiftable through a switcher with respect to one of the receiving-side optical fibers corresponding to the check optical signal to be output to the erroneous connection detector.

12: The wavelength multiplexing optical communication device according to claim 4, wherein
the demultiplexer is individually provided to the receiving-side optical fibers,
the second multiplexer is individually provided to the transmitting-side optical fibers of the second transmitter, and
the wavelength multiplexing optical communication device is made shiftable through a switcher with respect to one of the receiving-side optical fibers corresponding to the check optical signal to be multiplexed onto one of the transmitting-side optical fiber of the second transmitter.
